(19) United States
(12) Patent Application Publication
(10) Pub. No.: US 2011/0023389 A1
(43) Pub. Date: Feb. 3, 2011

(54) MODULAR DECK TILE

(75) Inventor: Christopher Myers, St. Helena, CA (US)

Correspondence Address: SNELL & WILMER L.L.P. (Main), 400 EAST VAN BUREN, ONE ARIZONA CENTER, PHOENIX, AZ, 85004-2202, US

(73) Assignee: Universal Exports, LLC

(21) Appl. No.: 12/829,252

(22) Filed: Jul. 1, 2010

Related U.S. Application Data
(60) Provisional application No. 61/222,369, filed on Jul. 1, 2009.

(51) Int. Cl. F21V 21/02; E04B 5/43

(52) U.S. Cl. 52/173.1; 52/483.1

(57) ABSTRACT

In an exemplary embodiment, a modular deck tile is designed to allow for the easy installation of roof top or balcony decks over existing surfaces, such as rolled roofing, waterproof or impermeable membranes. Advantages include the ability to be installed on a roof top surface without penetrating any waterproof membrane layers and cause leaking. The deck tiles may be made with recycled fiber composite decking or high density foam modular tiles. In another exemplary embodiment, the deck tile comprises an interlocking polyethylene base configured for the attachment of composite products or high density foam to be attached either in variety of shape configurations and in a variety of colors.

### CROSS REFERENCE TO RELATED APPLICATIONS

This application is a non-provisional of U.S. Provisional Application No. 61/222,369, entitled “MODULAR DECK TILE,” which was filed on Jul. 1, 2009, which is hereby incorporated by reference for any purpose in its entirety.

### SUMMARY

In an exemplary embodiment, a modular deck tile is designed to allow for the easy installation of roof top or balcony decks over existing surfaces, such as rolled roofing, waterproof or impermeable membranes. Advantages include the ability to be installed on a roof top surface without penetrating any waterproof membrane layers and cause leaking. The deck tiles may be made with recycled fiber composite decking or high density foam modular tiles. In another exemplary embodiment, the deck tile comprises an interlocking polyethylene base configured for the attachment of composite products or high density foam to be attached either in a variety of shape configurations and in a variety of colors.

Furthermore, LED lighting may be added to the decking material and used to create various lighting designs. In an exemplary embodiment, the deck tiles comprise power connections configured to provide power to the decking tiles via a grid system that does not require wiring between the individual deck tiles. This grid system of providing power is beneficial in terms of assembly simplicity and time needed to create the lighted deck system.

### BRIEF DESCRIPTION OF THE DRAWING FIGURES

A more complete understanding of the present invention may be derived by referring to the detailed description and claims when considered in connection with the drawing figures, wherein like reference numbers refer to similar elements throughout the drawing figures, and:

FIGS. 1a and 1b illustrate a top view and a side view of an exemplary embodiment of a grid base of a deck tile;

FIG. 2 illustrates a bottom view of an exemplary embodiment of a grid base of a deck tile;

FIG. 3 illustrates a perspective view of the top of an exemplary embodiment of a grid base;

FIG. 4 illustrates a perspective view of the bottom of an exemplary embodiment of a grid base;

FIG. 5 illustrates a sectional view of an exemplary dual beveled fastener point of a grid base;

FIG. 6 illustrates a sectional view of an exemplary alignment tab and a grid base;

FIG. 7a illustrates a perspective view of the top of an exemplary embodiment of a grid base;

FIG. 7b illustrates a close-up perspective view of the top of an exemplary embodiment of a grid base;

FIG. 8a illustrates a perspective view of the bottom of an exemplary embodiment of a grid base;

FIG. 8b illustrates a close-up perspective view of the bottom of an exemplary embodiment of a grid base;

FIG. 9 illustrates an exemplary embodiment of a reducer piece;

FIG. 10 illustrates an exemplary embodiment of four deck tiles;

FIG. 11 illustrates a close-up view of a grid base with an alignment tab in an exemplary embodiment;

FIGS. 12a and 12b illustrate an exemplary power grid system contained in a deck tile; and

FIG. 13 illustrates an exemplary embodiment of a light harness connected to a power source and connected to decking material.

### DETAILED DESCRIPTION OF THE INVENTION

While exemplary embodiments are described herein in sufficient detail to enable those skilled in the art to practice the invention, it should be understood that other embodiments may be realized and that logical material, electrical, and mechanical changes may be made without departing from the spirit and scope of the invention. Thus, the following detailed description is presented for purposes of illustration only.

In accordance with an exemplary embodiment, modular deck tiles are used to form a new decking surface on top of existing surfaces. The existing surfaces may include a concrete surface, a roof top surface, surfaces with waterproof membranes, brick surfaces, compacted earth, a wood framework, or any suitable level surface. In an exemplary embodiment, the deck tiles are free-floating on the underneath surface. In other words, the deck tiles are not screwed, nailed, or bonded to the underneath surface. An advantage of a free-floating deck system is that the deck system prevents the propagation of cracks or other settling issues in the existing surfaces. In other words, cracks appearing in the existing surface will not cause a free-floating surface deck system to similarly crack. A modular deck tile system is used to easily cover an existing surface with minimal structural changes or costly installation.

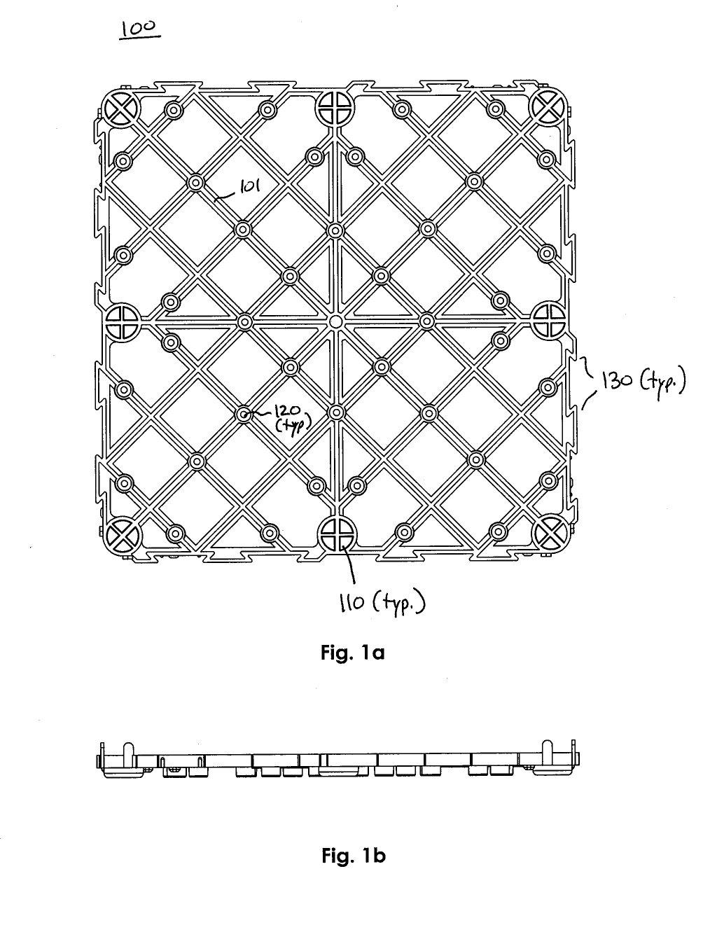

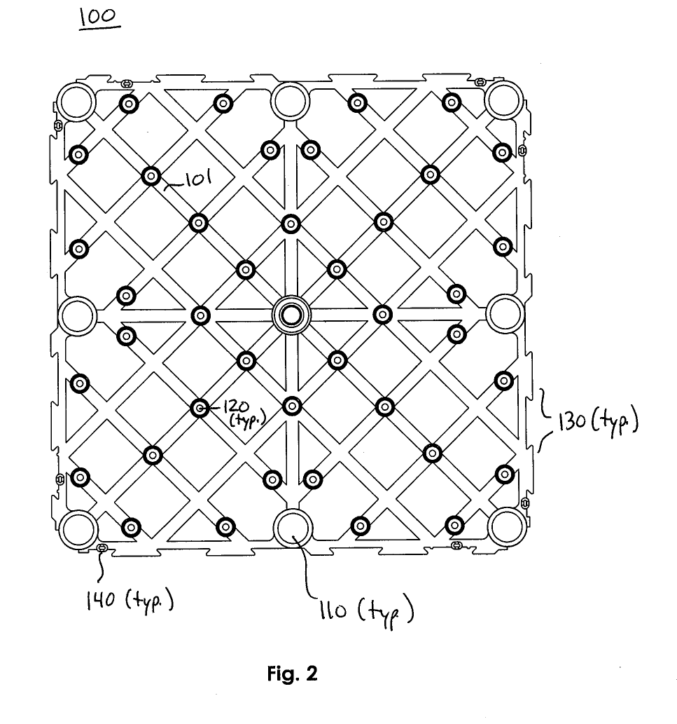

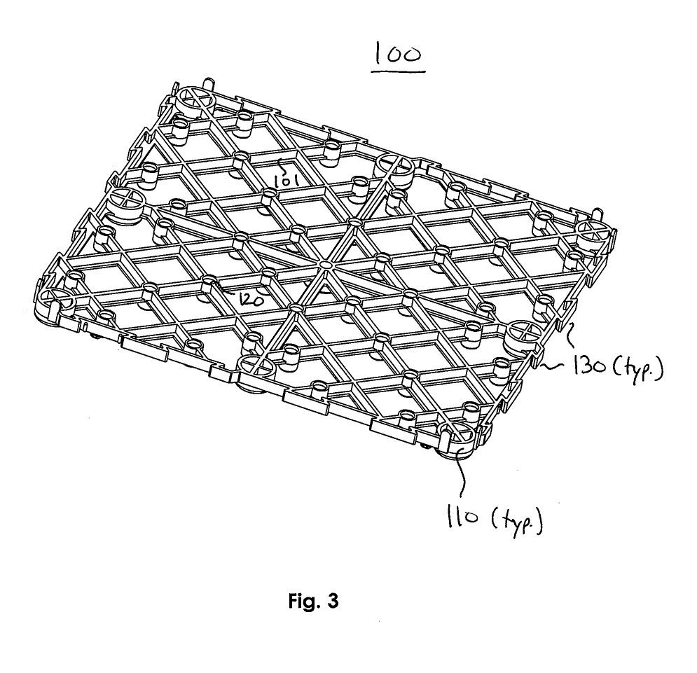

In accordance with an exemplary embodiment and with reference to FIG. 1, a deck tile 100 comprises a grid base 101, a plurality of feet 110 connected to grid base 101, and a plurality of fastener points 120 also connected to grid base 101. In an exemplary embodiment, deck tile 100 further comprises a shaped outer edge 130 configured to attach to another deck tile. For example, the edge of deck tile 100 may be shaped for a dovetail connection with another deck tile. In an exemplary embodiment, shaped outer edge 130 facilitates the connection of two deck tiles 100 such that a gap of less than ¼ inch results. In one embodiment, two deck tiles are connected with a gap of 3/16 inch between them. In general, a smaller gap space is more aesthetically pleasing to consumers than a larger gap. In an exemplary embodiment, deck tile 100 is 12″ square by ½″ thick, though other suitable dimensions are considered.

In an exemplary embodiment, deck tile 100 is made of many different combinations of plastic including polypropylene, polyethylene, ethylene vinyl acetate (EVA), or the like. Furthermore, in an exemplary embodiment, grid base 101 is configured to allow water to drain freely under the deck tiles by allowing space between deck tile 100 and the underneath surface. Furthermore, the open structure of grid base 101 prevents mold growth by facilitating air circulation around the tiles.

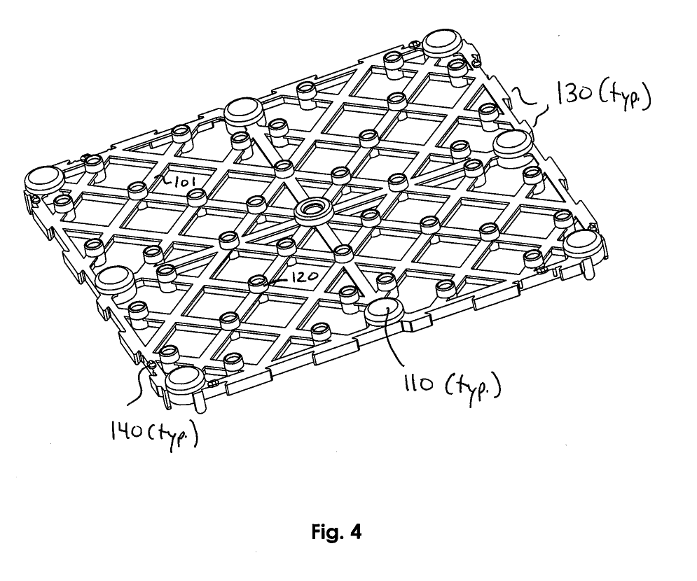

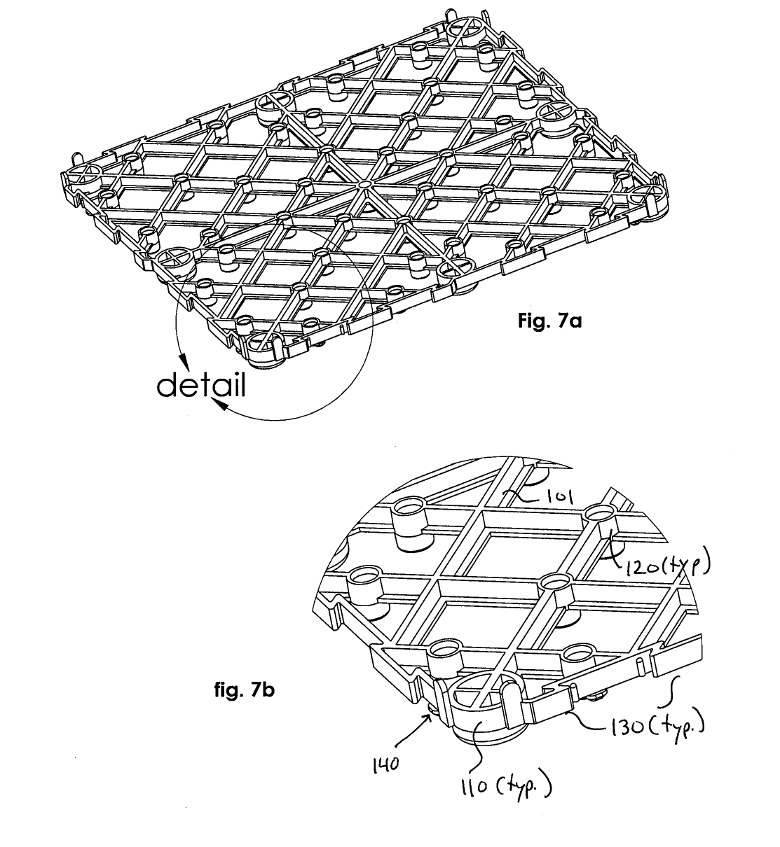

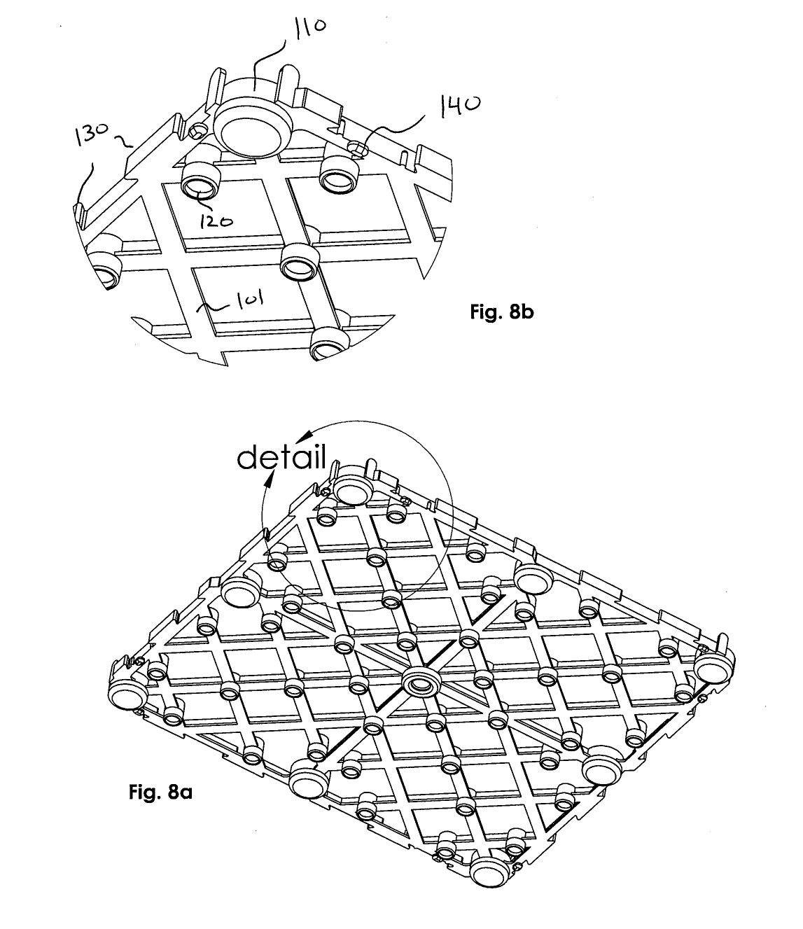

In addition to shaped outer edge 130, in an exemplary embodiment and with reference to FIG. 2, deck tile 100 further comprises alignment tabs 140. In an exemplary embodiment, and with reference to FIGS. 2, 4, 6, 7a, 7b, 8a, 8b and 11, alignment tabs 140 are built into the sides of grid base 101 and enable the tiles to be quickly, easily and accurately installed. They also provide a strong and secure means of locking each tile to the adjacent tiles. Alignment tabs 140 also facilitate lining up deck tiles 100 for installation. For example, alignment tabs 140 help to align the top surface of a first deck tile flush with the top surface of a second deck tile. In an exemplary embodiment, there is some space between the joints to allow for alignment tab 140 to slide down the face of the dovetail, and then alignment tab 140 helps lock the first and second deck tiles into position once the two top planes are aligned. In accordance with an exemplary embodiment and with momentary reference to FIG. 6, alignment tab 140 has a tapered shape to facilitate assembly. In other embodiments, alignment tab 140 has a rounded or square shape to facilitate assembly. In a first embodiment, alignment tab 140 is on the bottom surface of deck tile 100, along with the plurality of feet 110. In another embodiment, alignment tab 140 is on the top surface of deck tile 100 where decking material is attached, opposite the plurality of feet 110.

An advantage of the module deck tile system is that deck tile 100 can be removed from a deck tile system without requiring additional deck tiles to be removed. In an exemplary embodiment, deck tile 100 is made of flexible material, which facilitates the connection and disconnection of the tiles. Specifically, alignment tab 140 is able to slide down the face of shaped outer edge 130 because the edge of deck tile 100 is flexible enough to accommodate the displacement caused by alignment tab 140. Furthermore, the various alignment tabs 140 are offset from each other when connecting two deck tiles 140 together. Moreover, in an exemplary embodiment, in order to disconnect a deck tile from the deck tile system without removing additional tiles, a user pries the edge of deck tile 100 away from the adjacent tile until there is sufficient space to allow alignment tab 140 to release.

In an exemplary embodiment, each of the plurality of feet 110 is round shaped and/or not-pointed. The plurality of feet 110 are configured to distribute the weight of the decking tile and objects on the deck. In an exemplary embodiment, a deck tile comprises 4-16 feet per tile. In one embodiment, there are eight feet in a deck tile as shown in FIG. 1. However, any suitable number of feet may be used per deck tile. The shape of the plurality of feet 110 is designed to not penetrate waterproof membranes, which would negatively result in leaks. Thus, in an exemplary embodiment, a modular deck tile provides a modular, surface installed deck tile that spreads point loads to protect waterproof coatings or membranes utilizing fiber composite decking or high density foam. In accordance with another exemplary embodiment, feet 110 are made of solid material which can be shaped to accommodate non-flat surfaces. For example, feet 110 may be sanded or otherwise shaped to adapt to ridges or humps on the underneath surface and maintain an overlap level decking surface. In another exemplary embodiment, feet 110 are made of detachable segments which can be removed or snapped off to adjust the height of deck tile 100. In yet another exemplary embodiment, feet 110 are configured to couple to feet extensions which increase the height of deck tile 100. The feet extensions can be used to accommodate a depression or drop-off in the underneath surface. This ability to shape feet 110 is in contrast to shimming an entire decking surface to adjust to unlevel underneath surfaces.

In accordance with an exemplary embodiment, different decking material is attached to the top of deck tile 100 using plurality of fastener points 120. The decking material may include recycled fiber composite, high density foam, wood, plastic, cellular polyvinyl chloride (PVC), stone, ceramic tile, or recycled glass.

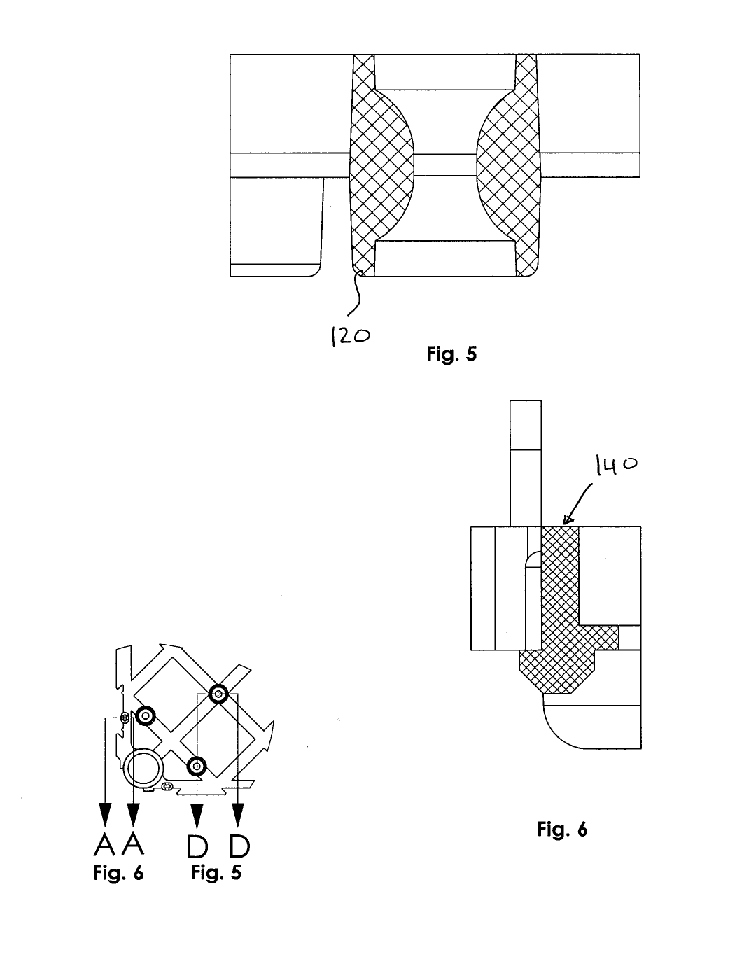

In an exemplary embodiment, fasteners are used to attach the decking material to the top of grid base 101. The fasteners include at least one of nails, screws, bolts, rivets, adhesive, and the like. In an exemplary embodiment, the fasteners connect the decking material to grid base 101 from the topside. In another exemplary embodiment, the fasteners connect the decking material to grid base 101 from underneath. In yet another exemplary embodiment, deck tile 100 is configured for the fasteners to connect the decking material to grid base 101 from the topside or underneath, and still provide a smooth surface. This may be accomplished by having a dual-beveled connection point in deck tile 100, as illustrated for example by FIG. 5. In one embodiment, grid base 101 may be connected to the decking material by inserting at least one fastener from underneath and further connected to a subframe by inserting at least one fastener from the topside.

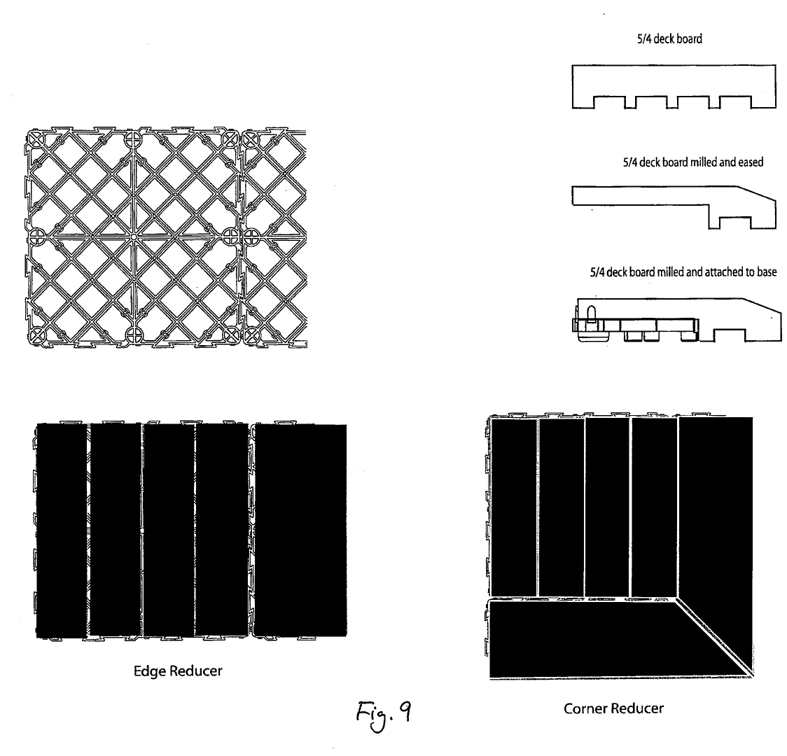

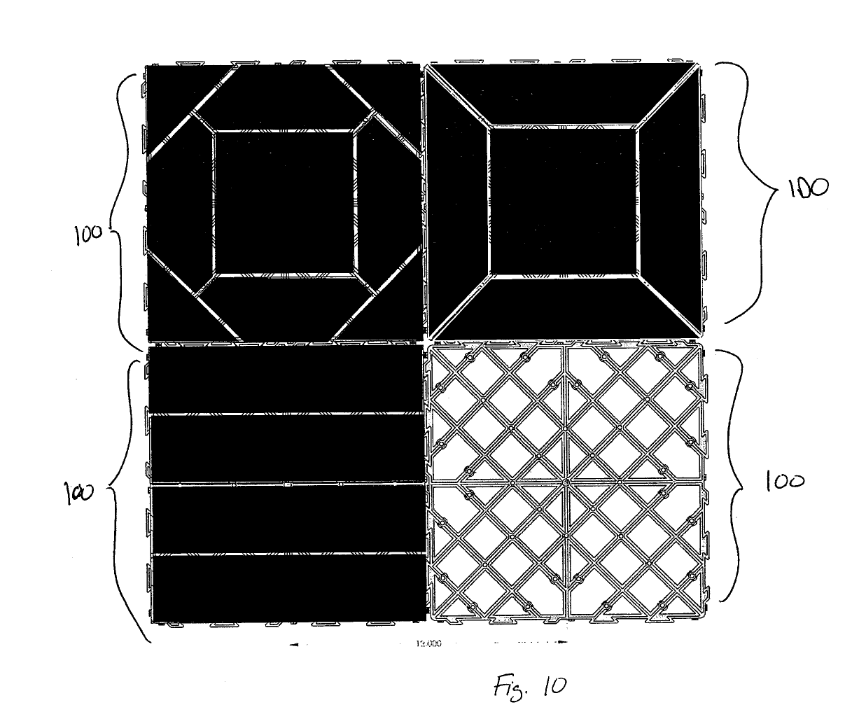

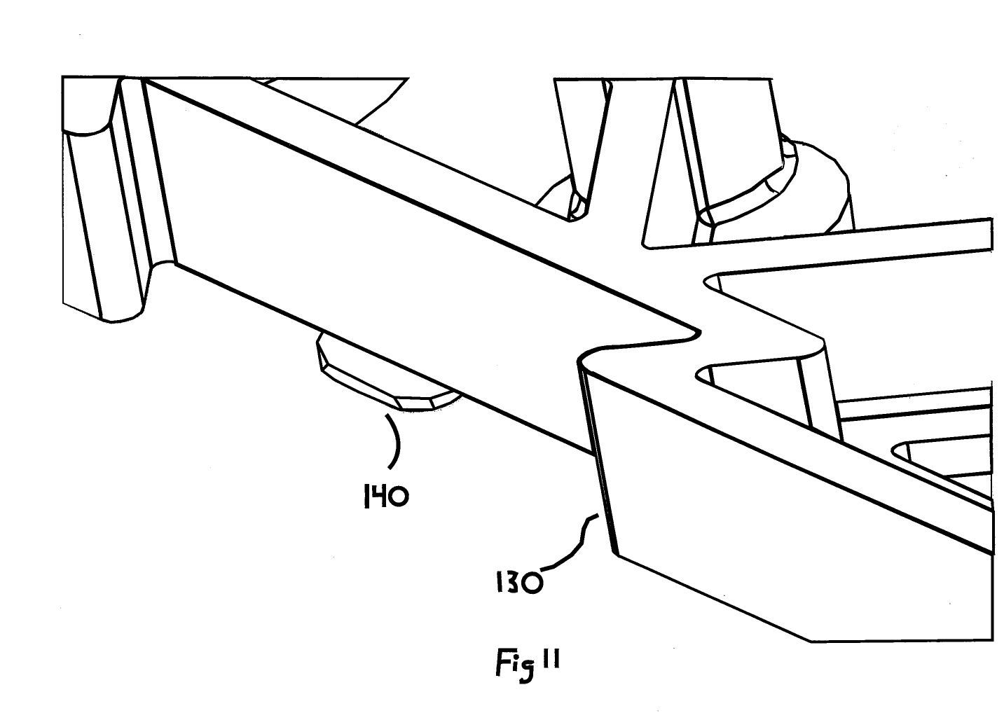

In an exemplary embodiment and with reference to FIG. 9, a reducer piece is used to provide a finished edge to the deck tile system. The reducer piece is attached to deck tile 100 at the edge of the overall deck tile system and hangs over the edge in order to visibly cover deck tile 100. In one embodiment, a deck board is milled and eased to create the reducer piece. The deck tile 100 may be cut as a partial deck tile to fit the necessary dimensions, as shown for example in FIG. 9. Furthermore, the reducer piece may be configured for a straight edge or for a corner edge, also as illustrated for example in FIG. 9. In an exemplary embodiment, a corner edge reducer comprises two edge reducers, which may have converge at a 45° angle, though other alignments are possible as would be understood by one skilled in the art.

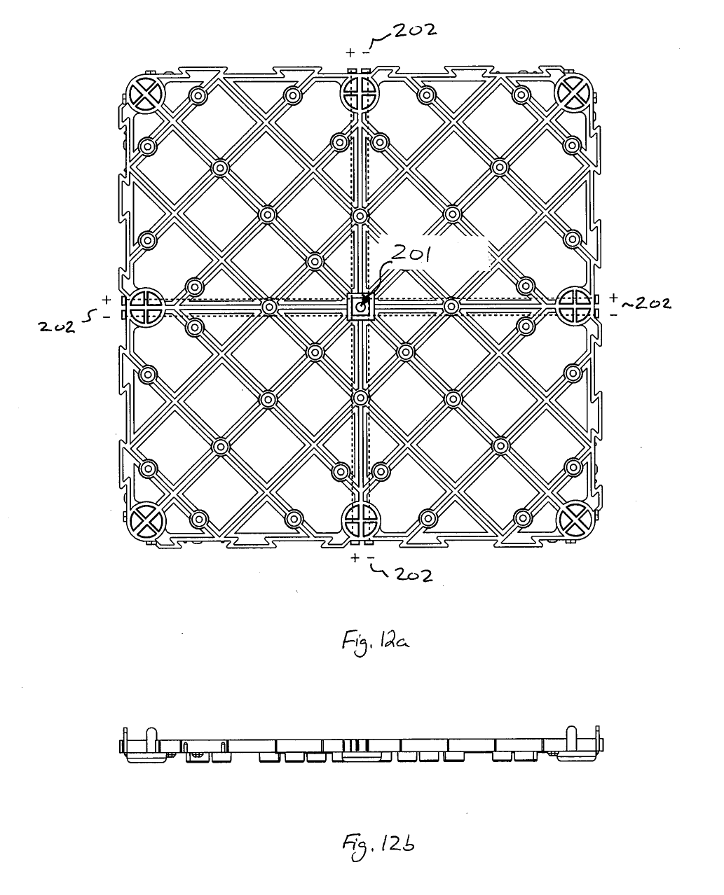

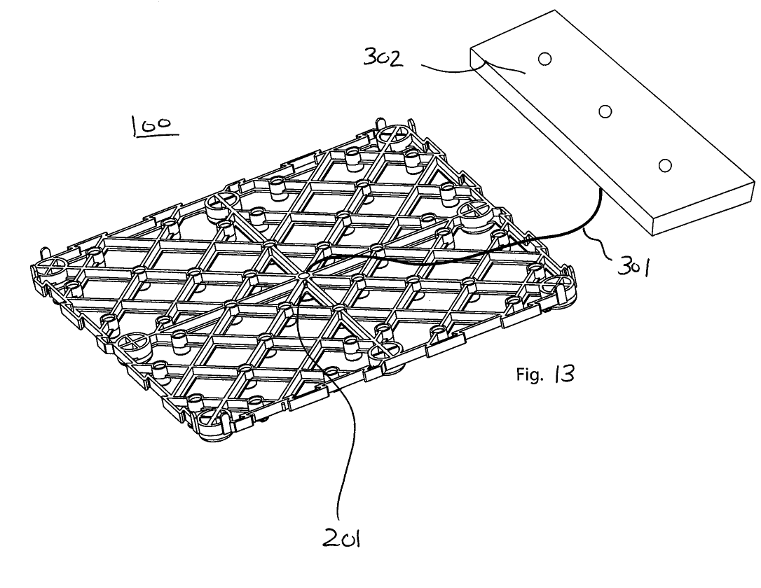

As an additional aspect, a decking tile may include lighting capabilities. In accordance with an exemplary embodiment and with reference to FIGS. 12a and 12b, a deck tile 100 further comprises a main power hub 201 and power lines connected to each of the sides. In the exemplary embodiment, a power connection post 202 comprises a positive post and a negative post and is located at each of the sides of deck tile 100. Furthermore, main power hub 201 may be located in the center of deck tile 100 though other locations within deck tile 100 may also be suitable. In an exemplary embodiment, main power hub 201 is a two-level hub having a top level and a bottom level. The top and bottom level facilitate connecting power terminals from all four directions. In one embodiment, wires are used to connect main power hub 201 to the various power connection posts 202 in deck tile 100.

Power connection post 202 is configured to electrically couple to another power connection post when decking tiles are connected. This electric coupling is advantageous because the connection can be made without the need to connect wires when assembling the deck in the field. Once one deck tile in an assembled deck grid is connected to a power source, the entire deck grid is connected to power via each power connection post 202. Moreover, in an exemplary embodiment, deck tile 100 can be oriented in any direction and still make an electrical connection to an adjacent deck tile due to the symmetry of deck tile 100. As a further advantage, in an exemplary embodiment, only one electrical connection is needed of all the possible electrical connections in order to provide power to main power hub 201. In other words, if deck tile 100 has four power connection posts 202 and one of power connection posts 202 has a faulty connection, main power hub 201 will still receive power. Approached from a deck tile grid system level, multiple electrical connection failures could occur without consequence.

In an exemplary embodiment and with reference to FIG. 13, a light harness 301 connects to main power hub 201 of deck tile 100. In one embodiment, light harness 301 comprises LED lights on a string wire with a positive/negative plug that may be replaced as needed. An exemplary light harness 301 may include a single LED light or multiple LED lights, including various colors or configurations. This flexibility allows for multiple lighting designs to be incorporated into the decking design. In an exemplary embodiment, a decking material 302 is designed or drilled in order to allow light harness 301 to be mounted and visibly display the lights. Typically, the lights are flush or slightly recessed with respect to decking material 302. One benefit of this design is that a single deck tile base design can accommodate many different decking materials 302 to be attached to the surface. In an exemplary embodiment, decking materials 302 can be designed or drilled out to attach to light harness 301. Moreover, in one embodiment, light harness 301 connects to main power hub 201 of deck tile 100. The power connection can be at least one of a wire connection, a surface connection, or any other suitable manner of electrically coupling main power hub 201 and light harness 301. Furthermore, in an exemplary embodiment, main power hub 201 may be electrically coupled to light posts, low voltage landscape features, and the like.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes,” “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. A modular deck tile comprising:
a grid base;
a plurality of feet connected to the grid base; and
a shaped outer edge configured to connect to another modular deck tile;
wherein the plurality of feet are configured to distribute weight loads and protect waterproof membranes.

2. The modular deck tile of claim 1, further comprising a plurality of fastener points, wherein the plurality of fastener points facilitate attachment of a decking material to the grid base, and wherein a fastener may be individually inserted into the plurality of fasteners from either above or below the grid base.

3. The modular deck tile of claim 2, wherein the fastener is at least one of a screw, nail, bolt, rivet, or adhesive.

4. The modular deck tile of claim 1, wherein the shaped outer edge is a dovetail joint, and wherein the modular deck tile attaches to another modular deck tile with a gap of 3/16″ of less.

5. The modular deck tile of claim 1, wherein the modular deck tile is made of at least of polypropylene, polyethylene, and ethylene vinyl acetate.

6. The modular deck tile of claim 1, further comprising a plurality of alignment tabs configured to facilitate installation and align a top surface of the modular deck tile flush with a top surface of an adjacent modular deck tile.

7. The modular deck tile of claim 6, wherein each of the plurality of alignment tabs is tapered.

8. The modular deck tile of claim 6, wherein the plurality of alignment tabs facilitate the installation and removal of the modular deck tile in a deck system without the removal of adjacent deck tiles.

9. The modular deck tile of claim 1, wherein each of the plurality of feet may be shaped to accommodate non-flat surfaces.

10. The modular deck tile of claim 1, wherein a decking material is attached to the modular deck tile, and wherein the decking material is at least one of recycled fiber composite, high density foam, wood, plastic, cellular polyvinyl chloride, stone, ceramic tile, or glass.

11. A modular deck tile comprising:
a grid base;
a shaped outer edge configured to connect to a second modular deck tile;
at least one power connection post configured to electrically couple to a power connection post of the second modular deck tile; and
a main power hub configured to receive power from the at least one power connection and provide power to at least one lighting source.

12. The modular deck tile of claim 11, wherein the at least one power connection post is wirelessly electrically coupled to the power connection post of the second modular deck tile.

13. The modular deck tile of claim 11, wherein the at least one lighting source is an LED light.

14. The modular deck tile of claim 11, wherein there is an individual at least one power connection post at each of the sides of the modular deck tile.
